(19) United States
(12) Patent Application Publication
(10) Pub. No.: US 2024/0230378 A1
(43) Pub. Date: Jul. 11, 2024

(54) MULTI-DEGREE-OF-FREEDOM DISPLACEMENT MEASURING DEVICE AND MULTI-DEGREE-OF-FREEDOM DISPLACEMENT MEASURING METHOD

(71) Applicant: MITUTOYO CORPORATION, Kawasaki (JP)

(72) Inventors: Yoshiaki Kato, Saitama (JP); Kimitoshi Ono, Kanagawa (JP); Shunsuke Tanaka, Kanagawa (JP)

(21) Appl. No.: 18/617,719

(22) Filed: Mar. 27, 2024

Related U.S. Application Data
(63) Continuation of application No. PCT/JP2022/036519, filed on Sep. 29, 2022.

(30) Foreign Application Priority Data
Sep. 30, 2021 (JP) 2021-161576

(51) Int. Cl. G01D 5/20; G01B 7/14

(52) U.S. Cl. CPC G01D 5/2086; G01B 7/14

(57) ABSTRACT

A multi-degree-of-freedom displacement measuring device includes a rotary scale that has a scale pattern including a plurality of patterns that are arranged around a first rotation axis and arrayed along a circumference direction of the rotary scale, a detection head group including a plurality of detection heads, each of which is provided around the first rotation axis, is arranged on an installation face facing the rotary scale, and is configured to detect each of the plurality of patterns from the scale pattern, and a calculator configured to, based on detection values acquired by the plurality of detection heads, calculate a relative rotation angle around the first rotation axis, and calculate at least one of a relative movement amount in a direction along the first rotation axis and a relative movement amount in a direction along a second rotation axis orthogonal to the first rotation axis.

### CROSS-REFERENCE TO RELATED APPLICATION

This application is based upon and claims the benefit of priority of the prior International Patent Application No. PCT/JP2022/036519, filed on Sep. 29, 2022, the entire contents of which are incorporated herein by reference.

### FIELD

A certain aspect of embodiments described herein relates to a multi-degree-of-freedom displacement measuring device and a multi-degree-of-freedom displacement measuring method.

### BACKGROUND

Conventionally, a rotary encoder is known as an angle detector that detects a rotation angle around a specific axis (see, for example, Japanese Patent Application Publication No. 2021-110670). The rotary encoder is attached to, for example, a joint portion of an industrial robot such as an assembly robot (see, for example, Japanese Patent Application Publication No. 2013-107175). Further, the rotary encoder may be incorporated in a machine tool and used for detecting the rotation angle of a turning shaft included in the machine tool (see, for example, Japanese Patent Application Publication No. 2020-001133).

### SUMMARY

In one aspect of the present invention, it is an object to provide a multi-degree-of-freedom displacement measuring device that can measure at least one of a rotation movement around a plurality of axes or a movement along the plurality of axes.

In an aspect, a multi-degree-of-freedom displacement measuring device includes: a rotary scale that has a scale pattern including a plurality of patterns that are arranged around a first rotation axis and arrayed along a circumference direction of the rotary scale; a detection head group including a plurality of detection heads, each of which is provided around the first rotation axis, is arranged on an installation face facing the rotary scale, and is configured to detect each of the plurality of patterns from the scale pattern; and a calculator configured to, based on detection values acquired by the plurality of detection heads, calculate a relative rotation angle around the first rotation axis, and calculate at least one of a relative movement amount in a direction along the first rotation axis and a relative movement amount in a direction along a second rotation axis orthogonal to the first rotation axis.

In another aspect, a multi-degree-of-freedom displacement measuring device includes: a rotary scale that has a scale pattern including a plurality of patterns that are arranged around a first rotation axis and arrayed along a circumference direction of the rotary scale; a detection head group including a plurality of detection heads, each of which is provided around the first rotation axis, is arranged on an installation face facing the rotary scale, and is configured to detect each of the plurality of patterns from the scale pattern; and a calculator configured to, based on detection values acquired by the plurality of detection heads, calculate a relative rotation angle around the first rotation axis, and calculate at least one of a relative movement amount in a direction along the first rotation axis and a relative rotation angle in a direction along a second rotation axis orthogonal to the first rotation axis.

In a still another aspect, a multi-degree-of-freedom displacement measuring device includes: a rotary scale that has a scale pattern including a plurality of patterns that are arranged around a first rotation axis and arrayed along a circumference direction of the rotary scale; a detection head group including a plurality of detection heads, each of which is provided around the first rotation axis, is arranged on an installation face facing the rotary scale, and is configured to detect each of the plurality of patterns from the scale pattern; and a calculator configured to, based on detection values acquired by the plurality of detection heads, calculate a relative rotation angle around the first rotation axis, and calculate at least one of a relative movement amount in a direction along the second rotation axis orthogonal to the first rotation axis and a relative rotation angle around the second rotation axis.

In an aspect, a measuring method of multi-degree-of-freedom displacement for measuring a multi-degree-of-freedom displacement by using a detection device including a rotary scale that has a scale pattern including a plurality of patterns that are arranged around a first rotation axis and arrayed along a circumference direction of the rotary scale, and a detection head group including a plurality of detection heads, each of which extends around the first rotation axis, is arranged on an installation face facing the rotary scale, and is configured to detect each of the plurality of patterns from the scale pattern, the method includes: based on detection values acquired by the plurality of detection heads, calculating a relative rotation angle around the first rotation axis; and calculating at least one of a relative movement amount in a direction along the first rotation axis and a relative movement amount in a direction along a second rotation axis orthogonal to the first rotation axis.

In another aspect, a measuring method of multi-degree-of-freedom displacement for measuring a multi-degree-of-freedom displacement by using a detection device including a rotary scale that has a scale pattern including a plurality of patterns that are arranged around a first rotation axis and arrayed along a circumference direction of the rotary scale, and a detection head group including a plurality of detection heads, each of which extends around the first rotation axis, is arranged on an installation face facing the rotary scale, and is configured to detect each of the plurality of patterns from the scale pattern, the method includes: based on detection values acquired by the plurality of detection heads, calculating a relative rotation angle around the first rotation axis; and calculating at least one of a relative movement amount in a direction along the first rotation axis and a relative rotation angle around a second rotation axis orthogonal to the first rotation axis.

In a still another aspect, a measuring method of multi-degree-of-freedom displacement for measuring a multi-degree-of-freedom displacement by using a detection device including a rotary scale that has a scale pattern including a plurality of patterns that are arranged around a first rotation axis and arrayed along a circumference direction of the rotary scale, and a detection head group including a plurality of detection heads, each of which extends around the first rotation axis, is arranged on an installation face facing the rotary scale, and is configured to detect each of the plurality of patterns from the scale pattern, the method includes: based on detection values acquired by the plurality of detection heads, calculating a relative rotation angle around the first rotation axis; and simultaneously calculating a relative movement amount in a direction along a second rotation axis orthogonal to the first rotation axis and a relative rotation angle around the second rotation axis.

### BRIEF DESCRIPTION OF DRAWINGS

FIG. 1 is a block diagram illustrating a configuration of a measuring device of an embodiment;

FIG. 2 is a plan view illustrating a schematic configuration of a rotary encoder included in a measuring device;

FIG. 3A illustrates three freedom degrees (X, Y, Z);

FIG. 3B illustrates other three freedom degrees (θx, θy, θz);

FIG. 4A is an explanatory diagram schematically showing a state in which a rotary scale is relatively eccentric along a Y-axis direction in a multi-degree-of-freedom displacement measuring device provided with two detection heads;

FIG. 4B is an explanatory diagram schematically showing a state in which a rotary scale is relatively eccentric along an X-axis direction in a multi-degree-of-freedom displacement measuring device provided with two detection heads;

FIG. 5A is an explanatory diagram schematically showing a state in which a rotary scale is rotated relative to a Y axis in a multi-degree-of-freedom displacement measuring device provided with two detection heads;

FIG. 5B is an explanatory diagram schematically showing a state in which a rotary scale is rotated relative to an X-axis in a multi-degree-of-freedom displacement measuring device provided with two detection heads;

FIG. 6 illustrates a state in which a rotary scale is relatively eccentric along a Y-axis direction and a relative eccentricity along the X-axis direction in a multi-degree-of-freedom displacement measuring device equipped with four detection heads;

FIG. 7 schematically shows a state in which a rotary scale is rotated relative to a Y axis and a state in which a rotary scale is rotated relative to an X axis in a multi-degree-of-freedom displacement measuring device equipped with four detection heads;

FIG. 8A is an explanatory diagram schematically showing N number of detection heads and a rotary scale;

FIG. 8B is an example of a sine wave drawn at a time of eccentricity detection in an X-axis direction and a Y-axis direction;

FIG. 8C is an example of a sine wave drawn when θx and θy are detected;

FIG. 9A is an explanatory diagram showing a relationship between an amount of eccentricity in an X-axis direction and a coefficient in a sine wave;

FIG. 9B illustrates an amount of eccentricity in a Y-axis direction and a coefficient in a sine wave;

FIG. 9C is an explanatory diagram showing a relationship between a rotation angle around an X axis and a coefficient in a sine wave;

FIG. 9D is a relationship between a rotation angle around a Y axis and a coefficient in a sine wave;

FIG. 10 is a perspective view of a robot to which a multi-degree-of-freedom displacement measuring device of an embodiment is applied;

FIG. 11 is an explanatory diagram illustrating a degree of freedom in a first joint portion of a robot illustrated in FIG. 10;

FIG. 12 is an explanatory diagram schematically illustrating how a robot illustrated in FIG. 10 is tilted at a first joint portion;

FIG. 13 is an explanatory diagram showing a part of a machine tool to which a multi-degree-of-freedom displacement measuring device of an embodiment is applied;

FIG. 14 is a plan view illustrating details of a configuration of a rotary encoder;

FIG. 15 is an explanatory diagram illustrating how detection heads are arranged on an installation surface facing a rotary scale;

FIG. 16 is an explanatory diagram illustrating an arrangement of a first detection head to a fourth detection head in a rotary encoder;

FIG. 17 is a plan view of a rotary scale;

FIG. 18 is an explanatory diagram illustrating a configuration of a receiving coil;

FIG. 19 is an explanatory diagram illustrating an example in which a receiving coil is formed on a printed wiring board; and

FIG. 20 is a diagram illustrating a correlation between a distance between a detection head and a rotary scale, and strength of a detection signal;

FIG. 21A and FIG. 21B are explanatory diagrams illustrating a movable area of a pattern provided in a scale pattern with respect to a rotary scale; and

FIG. 22A and FIG. 22B are explanatory diagrams illustrating a movable area of a pattern provided in a scale pattern with respect to a rotary scale.

### DESCRIPTION OF EMBODIMENTS

By the way, since the rotary encoder can detect the rotation angle around a specific axis, for example, the rotary encoder can detect an angle between links (arm members) connected via the joint portion when attached to a joint portion of a robot. When a robot has multiple joints, if a rotary encoder is attached to each joint and the detection value of each rotary encoder can be known, it is possible to know what kind of posture the robot is in. However, when the robot is in a state where the gripping object is gripped by, for example, an end effector provided at the tip end portion, the posture of the robot may change depending on the weight of the gripping object. In addition, the members constituting the rotation axis may be worn and misaligned. Such a change in the posture of the robot is caused by a movement that rotates around a plurality of axes and a combination of movements along a plurality of axial directions, that is, a complex movement due to a multi-degree-of-freedom displacement in the robot. Therefore, in order to grasp such a change in posture and obtain accurate position information of each part, a measuring device may be separately prepared in addition to the rotary encoder. When such a measuring device is installed, the size of the robot becomes large and the equipment of the factory becomes complicated.

A similar problem can occur in a machine tool equipped with a rotary encoder in the rotating part. In a machine tool, the tool attached to the swivel shaft may be misaligned or the swivel shaft may be subjected to rotational vibration. These phenomena may involve multi-degree-of-freedom displacement in the swivel axis. For this reason, since these phenomena cannot be accurately captured only by the conventional rotary encoder that only measures the rotation angle and rotation speed of the turning shaft, a monitoring device for monitoring these phenomena may be provided separately. The installation of such a monitoring device increases the size of the machine tool and complicates the equipment of the factory as in the case of the robot. Such problems can also occur in various machines other than robots and machine tools.

Hereinafter, embodiments will be described with reference to the drawings.

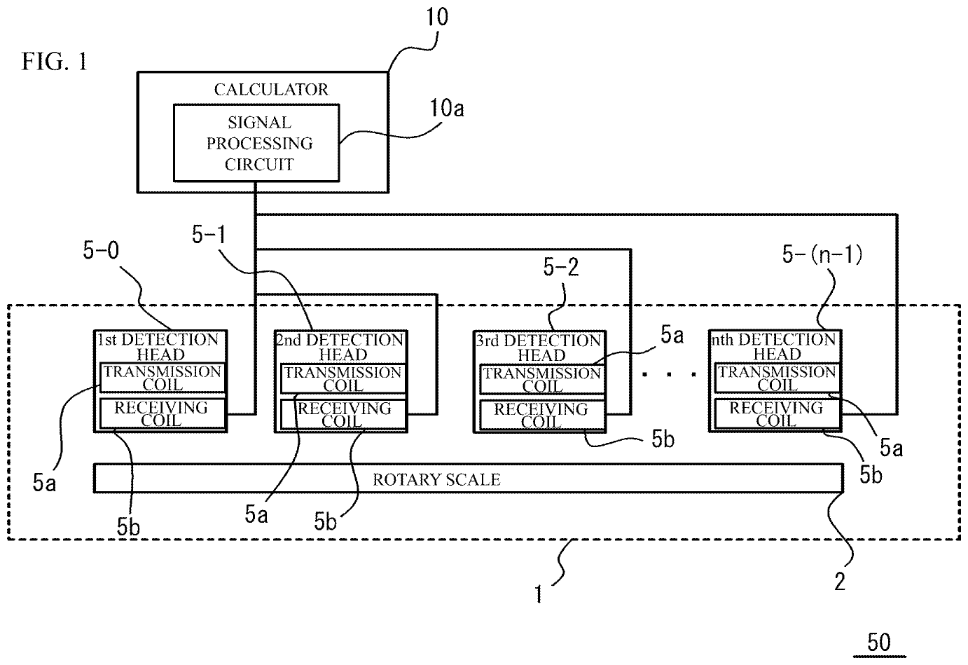

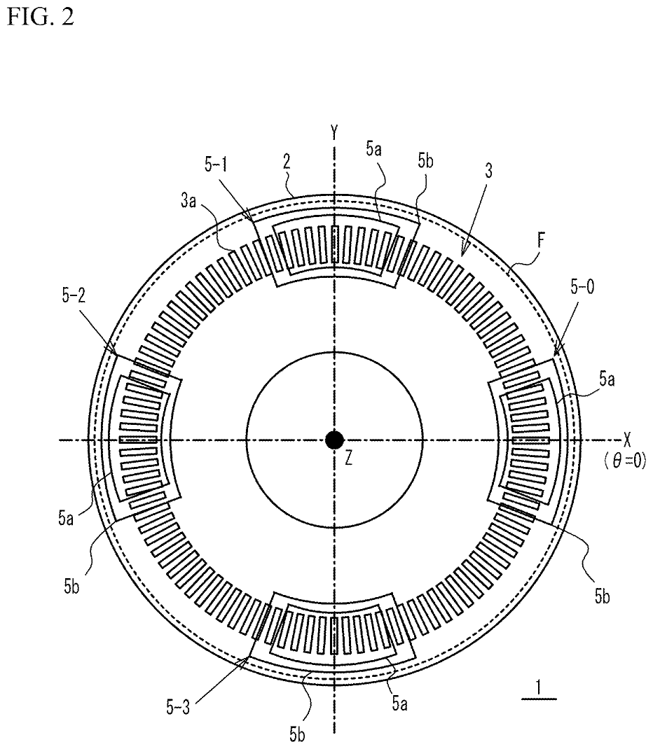

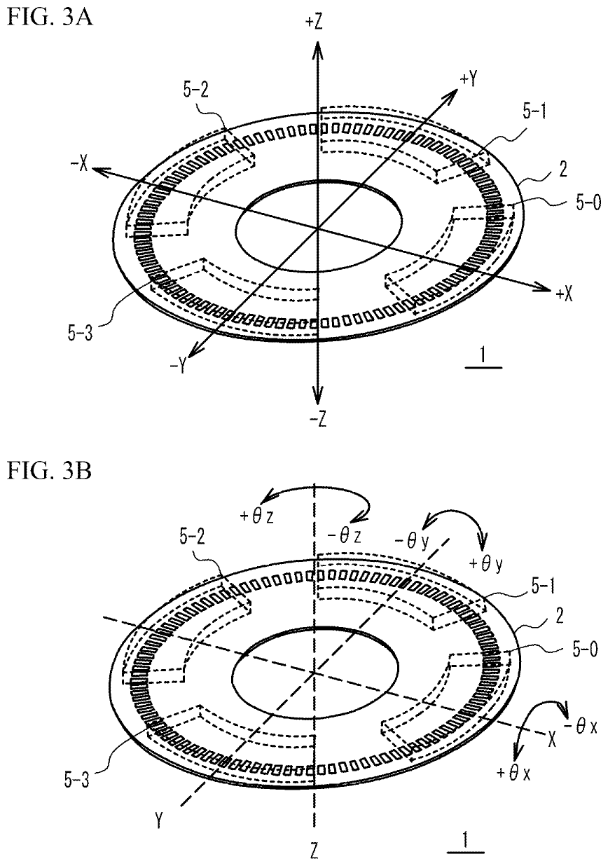

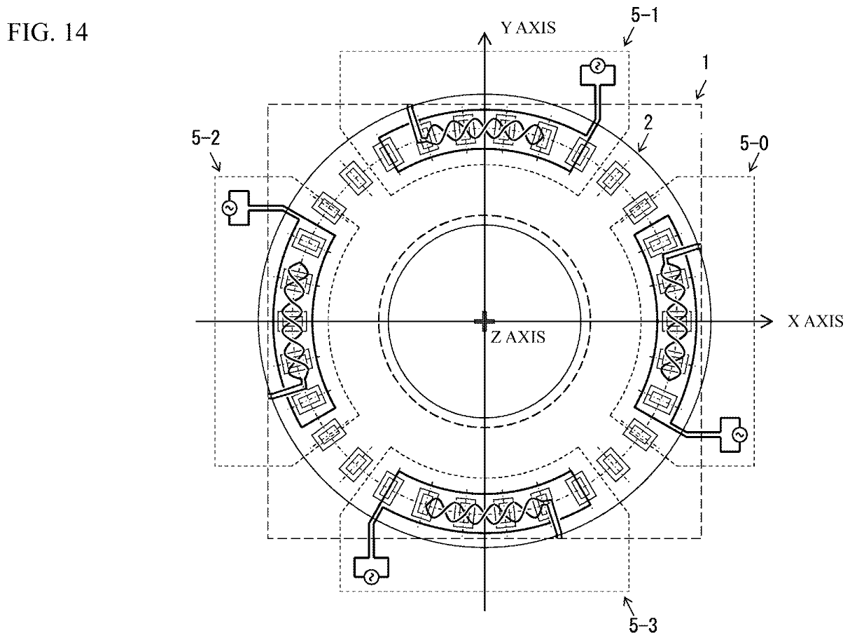

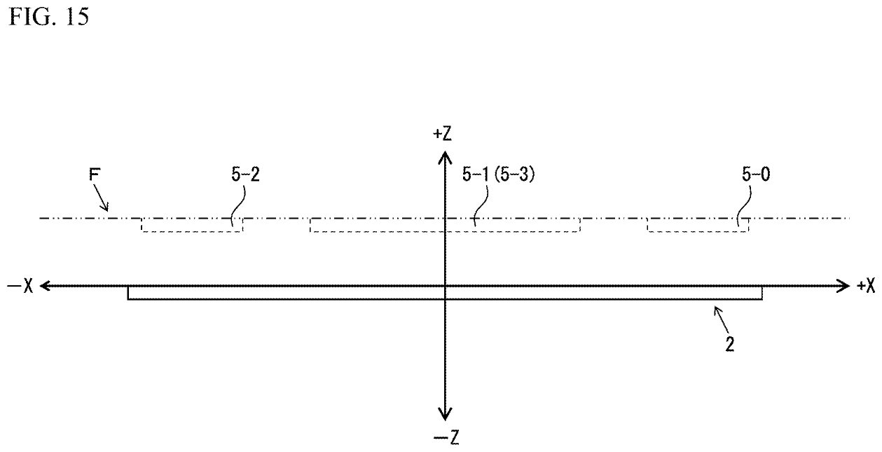

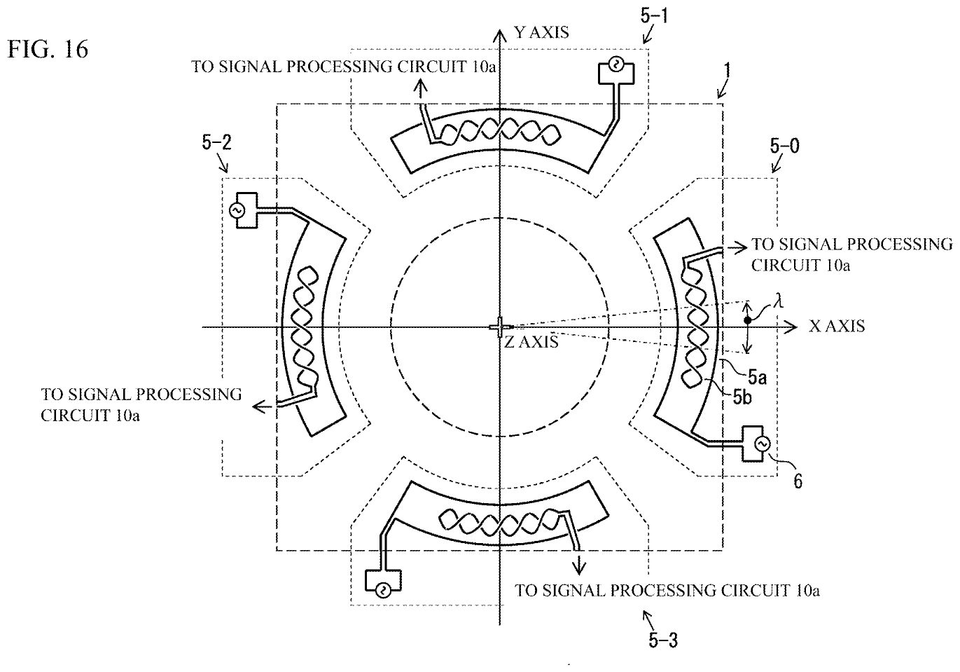

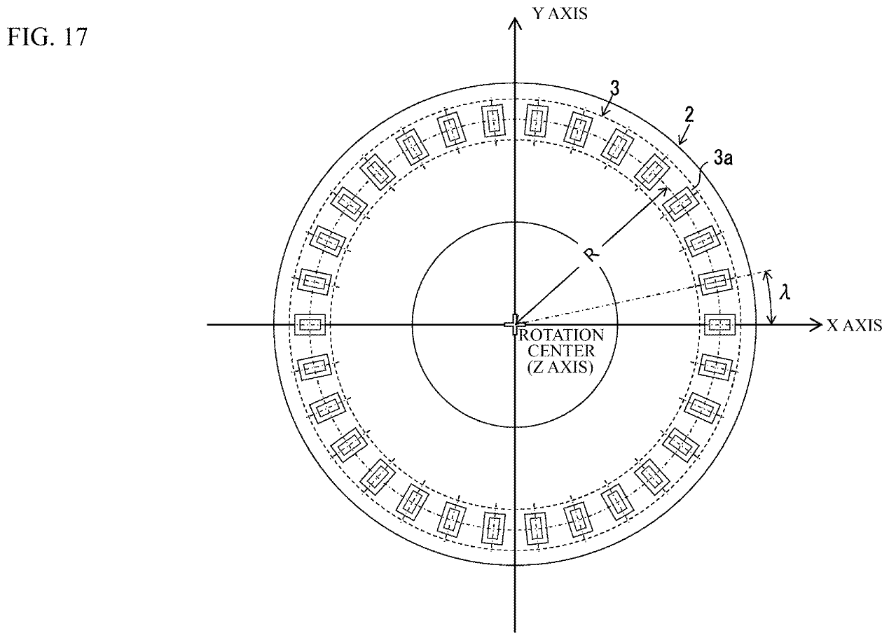

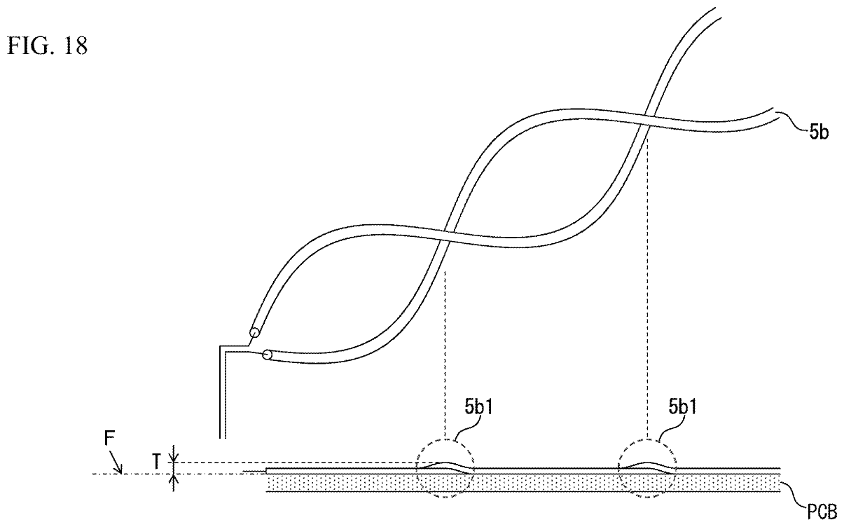

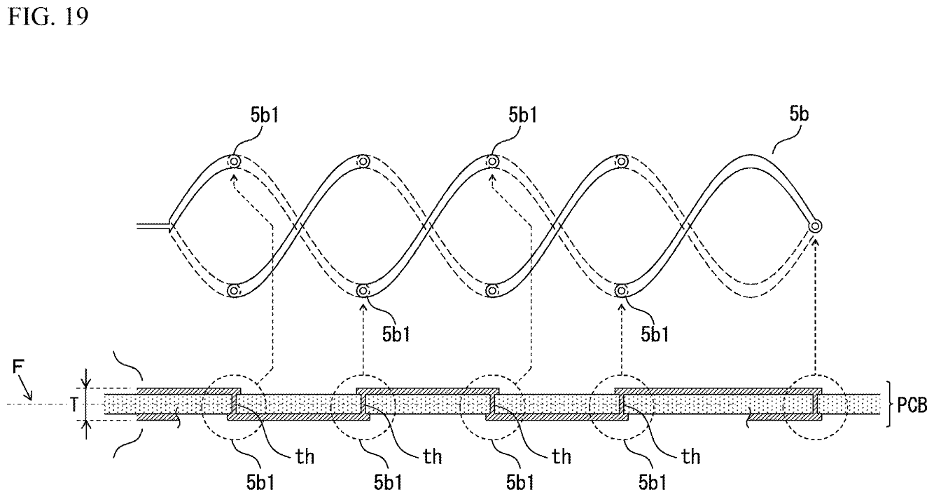

(Embodiment) First, the schematic configuration of the multi-degree-of-freedom displacement measuring device (hereinafter, simply referred to as “measuring device”) 50 of the embodiment will be described with reference to FIG. 1 to FIG. 3B and FIG. 14 to FIG. 22. FIG. 1 is a block diagram illustrating the configuration of the measuring device 50 of the embodiment. FIG. 2 is a plan view illustrating a schematic configuration of the rotary encoder 1 included in the measuring device 50. FIG. 3A is an explanatory diagram illustrating three degrees of freedom (X, Y, Z), and FIG. 3B is an explanatory diagram illustrating the remaining three degrees of freedom (θx, θy, θz). FIG. 14 is a plan view illustrating details of the configuration of the rotary encoder 1, and illustrates the rotary encoder 1 in a mode closer to the actual device than in FIG. 2. FIG. 15 is an explanatory diagram illustrating how the detection heads 5-0 to 5-(n−1) are arranged on the installation surface facing the rotary scale 2. FIG. 16 is an explanatory diagram illustrating the arrangement of the first detection head 5-0 to the fourth detection head 5-3 in the rotary encoder 1. FIG. 17 is a plan view of the rotary scale 2. FIG. 18 is an explanatory diagram illustrating the configuration of the receiving coil 5b. FIG. 19 is an explanatory diagram illustrating an example in which the receiving coil 5b is formed on a printed wiring board.

Referring to FIG. 1, the measuring device 50 includes a rotary encoder 1 and a calculator 10. The rotary encoder 1 includes a rotary scale 2 and n (“n” is an integer equal to 2 or more) detection heads 5-0 to 5-(n−1).

The rotary encoder 1 is illustrated in FIG. 3A, 3B, and FIG. 15. In order to define the detection axis of multi-degree-of-freedom displacement, FIG. 3A illustrates an eccentricity detection axis, and FIG. 3B illustrates an inclination detection axis. FIG. 15 illustrates the rotary encoder 1 when viewed from the −Y direction to the +Y direction in FIG. 3A. As illustrated in FIG. 15, the detection heads 5-0 to 5-(n−1) are arranged on an installation surface F facing the rotary scale 2. Note that the rotary encoder 1 illustrated in FIG. 2, FIG. 3A, FIG. 3B, and FIG. 15 is equipped with four detection heads from the first detection head 5-0 to the fourth detection head 5-3.

The detection heads 5-0 to 5-(n−1) are arranged around the Z-axis, which is the center of rotation of the rotary scale 2, as a central axis. The detection heads 5-0 to 5-(n−1) are each provided with a transmitting coil 5a and a receiving coil 5b. FIG. 16 illustrates the first detection head 5-0 to fourth detection head 5-3 arranged on the rotary encoder 1.

The transmitting coil 5a forms a fan-shaped coil whose length is in the circumferential direction. As illustrated in FIG. 16, the receiving coil 5b forms a detection loop that is repeated in the circumferential direction at a basic period 2, using a positive and negative sinusoidal waveform pattern with the basic period 2, inside the transmitting coil 5a.

As illustrated in FIG. 17, the rotary scale 2 is a disc-shaped member, and is installed on a rotating body whose multi-degree-of-freedom displacement is to be measured so that the rotation axis of the rotating body coincides with the rotation center (Z-axis). The rotary scale 2 has a scale pattern 3 including a plurality of patterns 3a arranged at the fundamental period λ along the circumferential direction of the rotary scale 2. The patterns 3a are a closed loop coils. Each of the patterns 3a is electromagnetically coupled to the transmitting coil 5a and also electromagnetically coupled to the receiving coil 5b.

A transmitting circuit 6 illustrated in FIG. 16 generates a single-phase AC drive signal and supplies the signal to the transmitting coil 5a. In this case, magnetic flux is generated in the transmitting coil 5a. As a result, electromotive currents are generated in the plurality of patterns 3a. The plurality of patterns 3a generate magnetic flux that changes at a predetermined spatial period in the circumferential direction by electromagnetically coupling with the magnetic flux generated by the transmitting coil 5a. The magnetic flux generated by the transmitting coil 5a causes an electromotive current to be generated in the receiving coil 5b. The electromagnetic coupling between the coils changes according to the amount of displacement of the rotary encoder 1, and a sine wave signal having the same period as the fundamental period A is obtained.

The installation surface F is, for example, a surface that includes the receiving coil 5b formed on the surface of a flat member. The flat member is, for example, a substrate. Each of the receiving coils 5b has a switching section 5b1 of a positive/negative sine waveform pattern. Therefore, as illustrated in FIG. 18, the receiving coil 5b has a thickness equal to the receiving coil thickness T as well as on the installation surface F. Further, as illustrated in FIG. 19, the receiving coil 5b can also be formed on a printed wiring board. In this case, the sinusoidal waveform pattern is arranged with an insulator in between, and a through hole th is arranged in the switching section 5b 1 to electrically connect the two. In addition, since the sinusoidal waveform patterns are placed apart by the receiving coil thickness T, by setting the installation surface F at the midline of the receiving coil thickness T, highly accurate detection with good signal balance is possible. Each of the receiving coils 5b is connected to a signal processing circuit 10a included in the calculator 10. And the signal acquired by each of the receiving coils 5b is used for the calculation in the calculator 10. Although each of the receiving coils 5b and the signal processing circuit 10a are connected by wire, they may be wirelessly connected.

In the rotary encoder 1 illustrated in FIG. 2, FIG. 3A and FIG. 3B, the first detection heads 5-0 to the fourth detection heads 5-3 are arranged at equal intervals in a circumferential shape. However, the spacing between the heads may be arbitrary, not necessarily equal spacing. However, by arranging the detection heads 5-0 to 5-(n−1) at equal intervals, the calculation performed by the calculator 10 described later becomes easy. Here, in other words, “the detection heads 5-0 to 5-(n−1) are arranged circumferentially at equal intervals” means that the Z-axis which is the center of rotation of the rotary scale 2 is the center axis, and the detection heads are arranged at equal angles on the circumference (on the circumference with the Z-axis as the central axis).

In the present embodiment, the transmission coil 5a is provided for each detection head. For example, one transmission coil may be provided independently, and the signal transmitted from this transmission coil toward the rotary scale 2 may be transmitted by each of the receiving coils 5b.

In the rotary encoder 1 of the present embodiment, the rotary scale 2 is mounted on the rotating body side to be the measurement target, but the installation surface F provided with the detection heads 5-0 to 5-(n−1) may be set on the body side. In short, the rotary encoder 1 may be installed so that the relative positional relationship between the rotary scale 2 and the installation surface F changes in the measurement target.

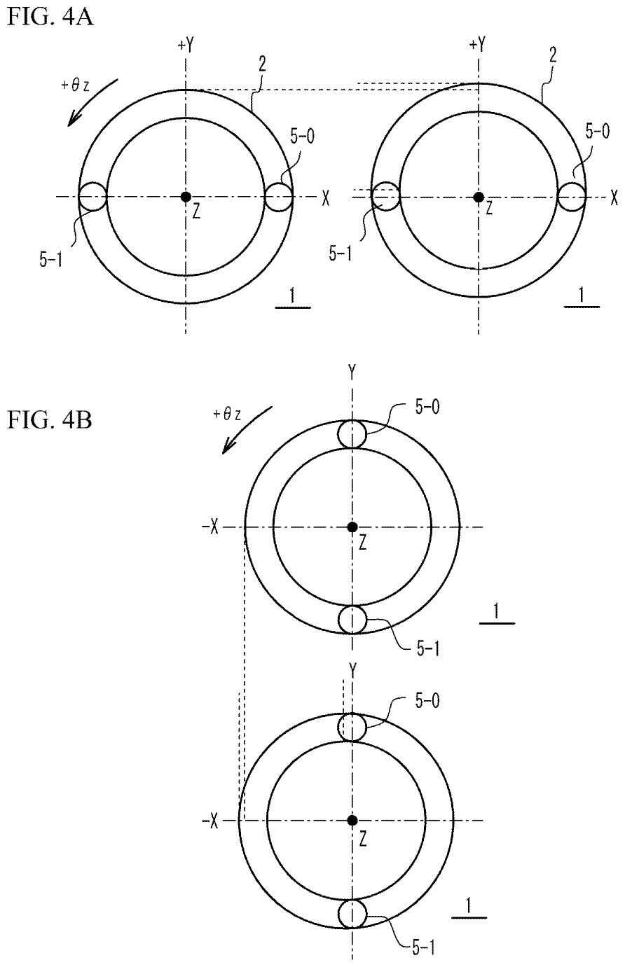

The rotary encoder 1 of the present embodiment is an electromagnetic induction type, but may use another detection principle such as a capacitance type or a photoelectric type. In the case of other types of rotary encoders, the transmitter coil and the receiver coil have a transmitter and a receiver corresponding to the format adopted by the rotary encoder, respectively.

[Measurement principle] Next, the principle of measuring the displacement with multiple degrees of freedom by the measuring device 50 will be described with reference to FIG. 4A to FIG. 9. Rotary encoders with different numbers and arrangements of detection heads are drawn in each figure. Strictly speaking, the detection heads and rotary encoders may differ between the figures, but for convenience of explanation, different detection heads and rotary encoders are drawn with use of a common reference number. Further, in each figure, the elements appearing in FIG. 2 and the like may be simplified or omitted.

First, a case where the rotary scale 2 is eccentric in the rotary encoder 1 provided with two detection heads will be described with reference to FIG. 4A and FIG. 4. Referring to FIG. 4A, the rotary encoder 1 includes two detection heads, that is, the first detection head 5-0 and the second detection head 5-1. In the rotary encoder 1 illustrated in FIG. 4A, the first detection head 5-0 and the second detection head 5-1 are arranged at positions 180° apart on the X-axis line. That is, the first detection head 5-0 and the second detection head 5-1 are arranged on opposite sides on the X-axis across the Z-axis.

In such the rotary encoder 1, it is assumed that the rotary scale 2 is eccentric to the +Y side as illustrated in the rotary encoder 1 illustrated on the right side of FIG. 4A. Then, the first detection head 5-0 shows a detection value as if the rotary scale 2 was rotated to the plus side (+θz) around the Z axis. On the other hand, the second detection head 5-1 shows a detection value as if the rotary scale 2 was rotated to the minus side (−θz) around the Z axis. When such a combination of detected values is obtained, it can be seen that the rotary scale 2 is relatively moved (eccentric) to the +Y side. The movement amount at this time is the absolute value of each of the detection value of the first detection head 5-0 and the detection value of the second detection head 5-1. If ± of the detection values of the first detection head 5-0 and the second detection head 5-1 are exchanged, the rotary scale 2 is relatively moved (eccentric) to the −Y side.

In the rotary encoder 1 illustrated in FIG. 4B, the first detection head 5-0 and the second detection head 5-1 are arranged at positions 180° apart on the Y-axis line. That is, the first detection head 5-0 and the second detection head 5-1 are arranged on opposite sides on the Y axis across the Z axis.

In such the rotary encoder 1, it is assumed that the rotary scale 2 is eccentric to the −X side as illustrated in the rotary encoder 1 illustrated on the lower side of FIG. 4B. Then, the first detection head 5-0 shows a detection value as if the rotary scale 2 was rotated to the plus side (+θz) around the Z axis. On the other hand, the second detection head 5-1 shows a detection value as if the rotary scale 2 was rotated to the minus side (−θz) around the Z axis. When such a combination of detected values is obtained, it can be seen that the rotary scale 2 is relatively moved (eccentric) to the −X side. The movement amount at this time is the absolute value of each of the detection value of the first detection head 5-0 and the detection value of the second detection head 5-1. If ± of the detection values of the first detection head 5-0 and the second detection head 5-1 are exchanged, the rotary scale 2 is relatively moved (eccentric) to the +X side.

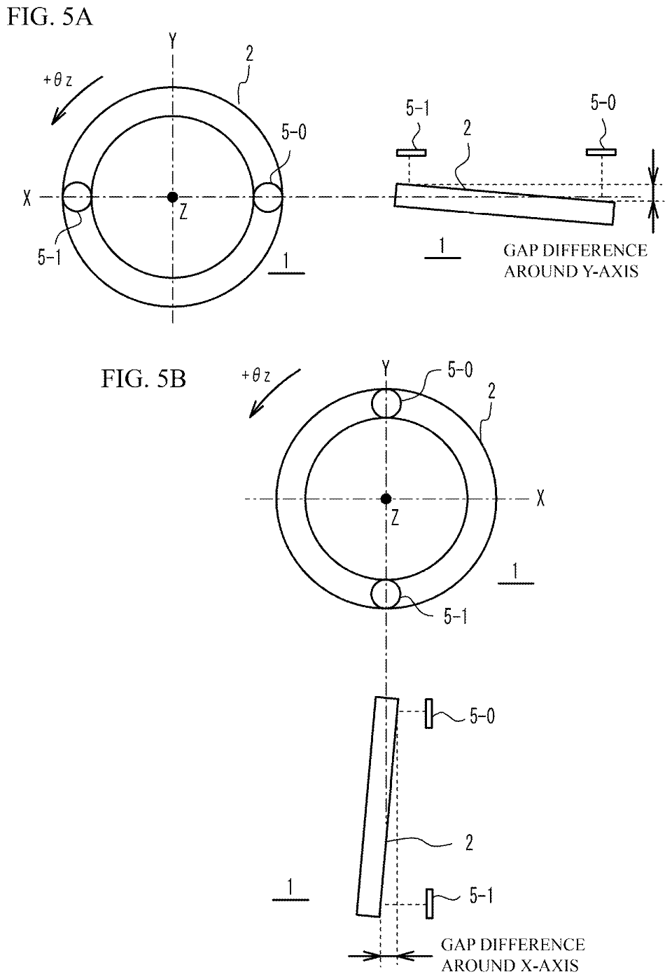

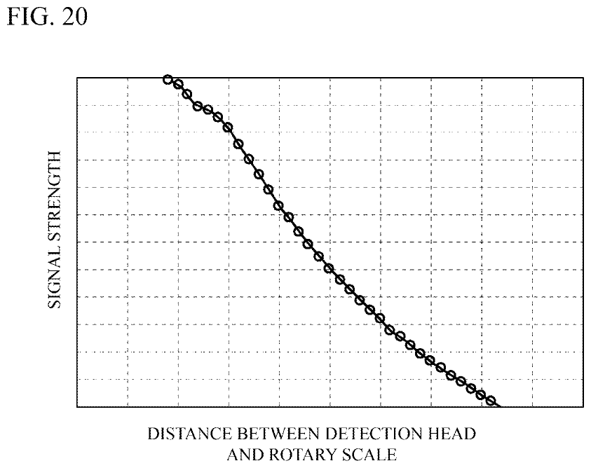

Next, a case where the rotary scale 2 is tilted in the rotary encoder 1 provided with two detection heads will be described with reference to FIG. 5A and FIG. 5. Referring to FIG. 5A, the rotary encoder 1 includes the first detection head 5-0 and the second detection head 5-1 like the rotary encoder 1 illustrated in FIG. 4A. Here, the distance between the detection head and the rotary scale 2 has a correlation with the strength of the detection signal. Specifically, when the distance between the detection head and the rotary scale 2 is close (small gap), the strength of the detection signal becomes large (strong), and when the distance between the detection head and the rotary scale 2 is long (separated, and gap is large), the strength of the detection signal becomes small (weak). FIG. 20 is a diagram illustrating the correlation between the distance between the detection head and the rotary scale 2, and the strength of the detection signal obtained from the receiving coil. In FIG. 2, the horizontal axis indicates the distance [mm] between the two, and the vertical axis indicates the signal strength. Since the detection method of the rotary encoder 1 of this embodiment uses an electromagnetic induction method between the transmitting coil and the receiving coil, as illustrated in FIG. 20, the signal strength decreases as the distance increases, and as the distance decreases, signal strength increases. The relationship of FIG. 20 between the distance between the detection head and the rotary scale 2, and the strength of the detection signal, is stored in the calculator 10, and the strength of the detection signal obtained from each detection head is applied to the Y axis in FIG. 20. Accordingly, the distance between each detection head and the rotary scale 2 can be calculated.

In such the rotary encoder 1, it is assumed that the rotary scale 2 is rotated in the +θy direction (clockwise direction in FIG. 5A) as illustrated in the rotary encoder 1 illustrated on the right side of FIG. 5A. Then, the distance detected by the first detection head 5-0 between the first detection head 5-0 and the rotary scale 2 is larger than the distance detected by the second detection head 5-1 between the second detection head 5-1 and the rotary scale 2. When such a combination of detected values is obtained, it can be seen that the rotary scale 2 is relatively rotated in the +θy direction. The amount of rotation at this time can be calculated from the difference between the detection value of the first detection head 5-0 and the detection value of the second detection head 5-1. When the distance between the second detection head 5-1 and the rotary scale 2 is larger than the distance between the first detection head 5-0 and the rotary scale 2, the rotary scale 2 is rotated relatively to the −θy side.

Referring to FIG. 5B, the rotary encoder 1 includes the first detection head 5-0 and the second detection head 5-1 like the rotary encoder 1 illustrated in FIG. 4B. In this case as well, the distance between each detection head and the rotary scale 2 is calculated based on the strength of the detection signal.

In such the rotary encoder 1, it is assumed that the rotary scale 2 is rotated in the +θx direction (clockwise direction in FIG. 5B) as illustrated in the rotary encoder 1 illustrated on the lower side of FIG. 5B. Then, the distance detected by the second detection head 5-1 between the second detection head 5-1 and the rotary scale 2 is larger than the distance detected by the first detection head 5-0 between the first detection head 5-0 and the rotary scale 2. When such a combination of detected values is obtained, it can be seen that the rotary scale 2 is relatively rotated in the +θx direction. The amount of rotation at this time can be calculated from the difference between the detection value of the first detection head 5-0 and the detection value of the second detection head 5-1. When the distance between the first detection head 5-0 and the rotary scale 2 is larger than the distance between the second detection head 5-1 and the rotary scale 2, the rotary scale 2 is rotated relatively to the −θx side.

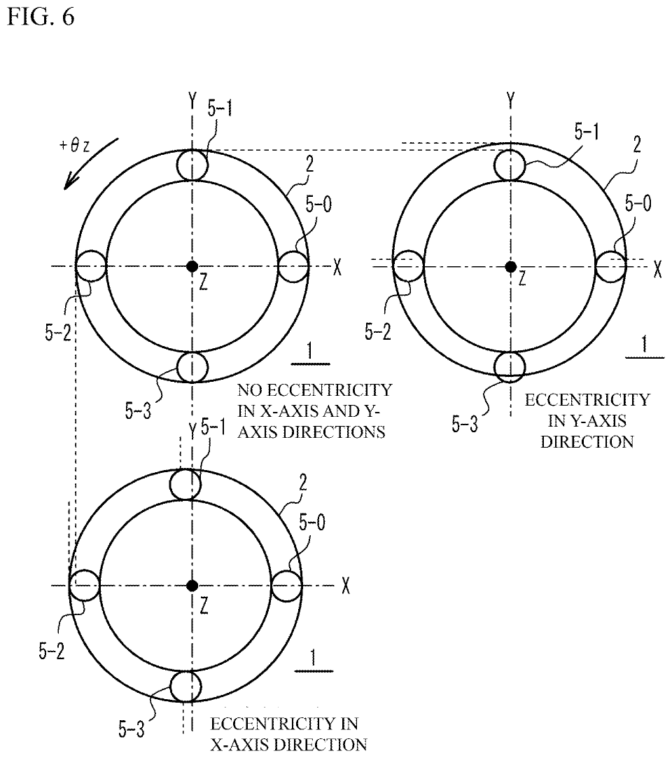

Next, with reference to FIG. 6, a case where the rotary scale 2 is eccentric in the rotary encoder 1 provided with four detection heads will be described. Referring to FIG. 6, the rotary encoder 1 has four detection heads, that is, the first detection head 5-0, the second detection head 5-1, the third detection head 5-2 and the fourth detection head 5-3. In the rotary encoder 1, the first detection head 5-0 and the third detection head 5-2 are arranged at positions 180° apart from each other on the X-axis line. And the second detection head 5-1 and the fourth detection head 5-3 are arranged at positions 180° apart from each other on the Y-axis. That is, the first detection head 5-0 and the third detection head 5-2 are arranged on opposite sides on the X axis across the Z axis. And the second detection head 5-1 and the fourth detection head 5-3 are arranged on opposite side of the Y-axis across the Z-axis. The first detection heads 5-0 to the fourth detection heads 5-3 are arranged at equal intervals of 90° each.

In such the rotary encoder 1, it is assumed that the rotary scale 2 is eccentric to the +Y side as illustrated in the rotary encoder 1 illustrated on the right side of FIG. 6. Then, the first detection head 5-0 shows a detection value as if the rotary scale 2 was rotated to the plus side (+θz) around the Z axis. On the other hand, the third detection head 5-2 shows a detection value as if the rotary scale 2 was rotated to the minus side (−θz) around the Z axis. The detection value of the second detection head 5-1 and the detection value of the fourth detection head 5-3 both show the value when there is no rotation around the Z axis. When such a combination of detected values is obtained, it can be seen that the rotary scale 2 is relatively moving to the +Y side. The movement amount at this time is the absolute value of each of the detection value of the first detection head 5-0 and the detection value of the third detection head 5-2. If ± of the detection value of the first detection head 5-0 and the detection value of the third detection head 5-2 are exchanged, the rotary scale 2 is relatively moved to the −Y side.

In the rotary encoder 1 illustrated in FIG. 6, it is assumed that the rotary scale 2 is eccentric to the −X side as illustrated in the lower side of FIG. 6. Then, the second detection head 5-1 shows a detection value as if the rotary scale 2 was rotated to the plus side (+θz) around the Z axis. On the other hand, the fourth detection head 5-3 shows a detection value as if the rotary scale 2 was rotated to the minus side (−θz) around the Z axis. The detection value of the first detection head 5-0 and the detection value of the third detection head 5-2 both show the value when there is no rotation around the Z axis. When such a combination of detected values is obtained, it can be seen that the rotary scale 2 is relatively moving to the −X side. The amount of movement at this time is the absolute value of each of the detection value of the second detection head 5-1 and the detection value of the fourth detection head 5-3. If ± of the detection value of the second detection head 5-1 and the detection value of the fourth detection head 5-3 are exchanged, the rotary scale 2 is relatively moved to the +X side.

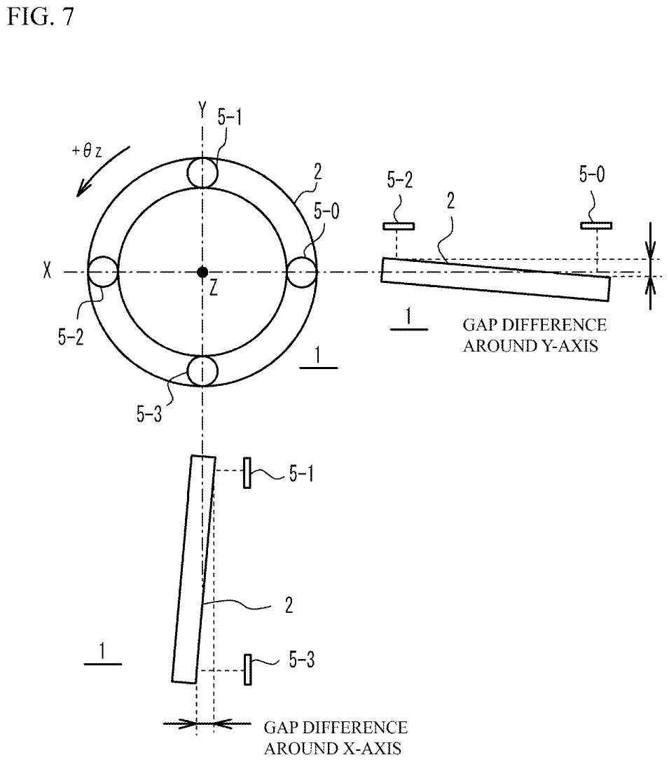

Next, with reference to FIG. 7, a case where the rotary scale 2 is tilted in the rotary encoder 1 provided with four detection heads will be described. Referring to FIG. 7, the rotary encoder 1 includes the first detection head 5-0 to the fourth detection head 5-3 like the rotary encoder 1 illustrated in FIG. 6. The distance between each detection head and the rotary scale 2 is calculated based on the intensity of the detection signal of each detection head.

In such the rotary encoder 1, it is assumed that the rotary scale 2 is rotated in the +θy direction (clockwise in FIG. 7) as in the rotary encoder 1 illustrated on the right side of FIG. 7. Then, the distance detected by the first detection head 5-0 between the first detection head 5-0 and the rotary scale 2 is larger than the distance detected by the third detection head 5-2 between the third detection head 5-2 and the rotary scale 2. Then, the detection value of the second detection head 5-1 and the detection value of the fourth detection head 5-3 show the same value. When such a combination of detected values is obtained, it can be seen that the rotary scale 2 is relatively rotated in the +θy direction. The amount of rotation at this time can be calculated from the difference between the detection value of the first detection head 5-0 and the detection value of the third detection head 5-2. When the distance between the third detection head 5-2 and the rotary scale 2 is larger than the distance between the first detection head 5-0 and the rotary scale 2, the rotary scale 2 is rotated relatively to the −θy side.

In such the rotary encoder 1, it is assumed that the rotary scale 2 is rotated in the +θx direction (clockwise in FIG. 7) as in the rotary encoder 1 illustrated on the lower side of FIG. 7. Then, the distance detected by the fourth detection head 5-3 between the fourth detection head 5-3 and the rotary scale 2 is larger than the distance detected by the second detection head 5-1 between the second detection head 5-1 and the rotary scale 2. Then, the detection value of the first detection head 5-0 and the detection value of the third detection head 5-2 show the same value. When such a combination of detected values is obtained, it can be seen that the rotary scale 2 is relatively rotated in the +ex direction. The amount of rotation at this time can be calculated from the difference between the detected value of the second detection head 5-1 and the detected value of the fourth detection head 5-3. When the distance between the second detection head 5-1 and the rotary scale 2 is larger than the distance between the fourth detection head 5-3 and the rotary scale 2, the rotary scale 2 is rotated relatively to the −θx side.

FIG. 4A to FIG. 7 have described the case where the number of detection heads is two and the case where the number of detection heads is four, but if the number of detection heads is two or more, the displacement with multiple degrees of freedom can be measured in the same manner. The rotation around the Z axis can be detected from the detection value of each detection head as in the conventional rotary encoder. The rotation angle (rotation amount) around the Z axis can be, for example, the average value of the detection values (angle output) of each detection head. Further, the average value of the distances between each detection head and the rotary scale 2 calculated based on the detection of each detection head can be used as the relative movement amount along the Z-axis direction.

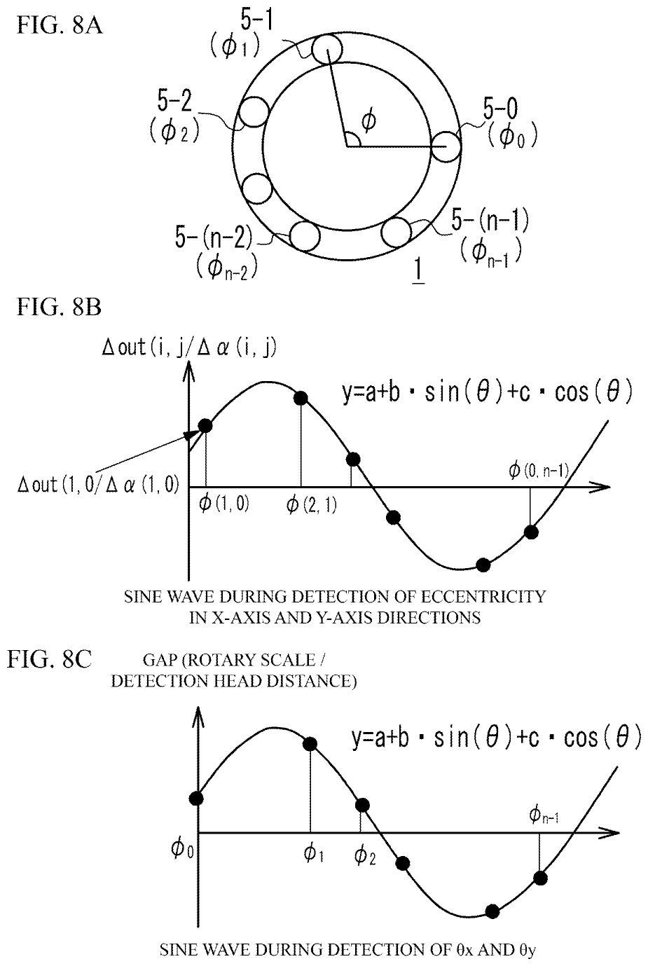

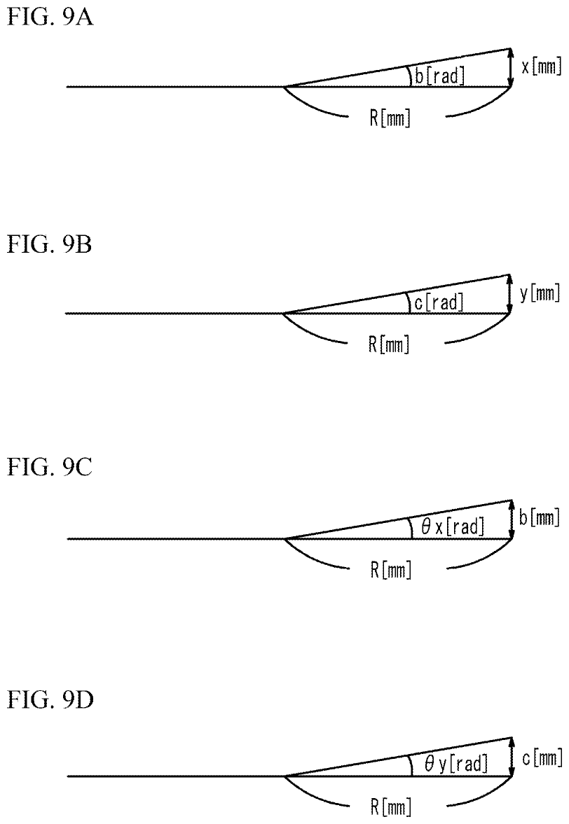

Next, the calculation of the displacement of the degrees of freedom included in the multiple degrees of freedom will be described with reference to FIG. 8A to FIG. 9. The displacement of the degree of freedom is calculated by the calculator illustrated in FIG. 1.

In the following description, the rotary encoder 1 illustrated in FIG. 8A will be referred to. The rotary encoder 1 illustrated in FIG. 8A includes n number of detection heads from the first detection head 5-0 to the n-th detection head 5-(n−1). Φ in the figure indicates the installation position of each detection head. Specifically, Φ shows a clockwise angle with the installation position 40 of the first detection head 5-0 as a reference position.

<When the rotary scale is relatively eccentric> First, a case where the rotary scale 2 is relatively eccentric with respect to the detection head group will be described with reference to FIG. 8B. The relative movement amount X (eccentricity amount) along the X-axis direction and the relative movement amount Y (eccentricity amount) along the Y-axis direction can be obtained from the amplitude and phase of the eccentricity error. Of the n number of detection heads, the angle output outk of the k-th (k=0 to n−1) detection head is expressed as a sum (see equation (1)) of the ideal angle output, that is, the angle output obtained when there is no eccentricity, and the eccentricity error.

$$Out k = ideal angle output ( k ) + eccentricity error ( k ) \qquad [ Equation 1 ]$$

Here, consider the difference between the angular outputs of the two detection heads i and the detection head j (see equation (2)).

$${Out}_{i} - {Out}_{j} = ideal angle output ( i ) - ideal angle output ( j ) + eccentricity error ( i ) - eccentricity error ( j ) \qquad [ Equation 2 ]$$

Since “the ideal angle (i)−ideal angle (j)” coincides with the difference “φi−φj” in the arrangement of the two detection heads, the eccentricity error can be extracted by defining Δout in the following equation (3).

$$Δ Out ( i , j ) = {Out}_{i} - {Out}_{j} - ( {Φ}_{i} - {Φ}_{j} ) = eccentricity error ( i ) - eccentricity error ( j ) \qquad [ Equation 3 ]$$

Here, assuming that the amplitude of the eccentricity error is α and the phase of the eccentricity error is β when φ=0 is used as a reference, these can be expressed by the following equation (4).

$$\begin{matrix}Eccentricity error ( i ) = α sin ( {Φ}_{i} + β ) \\ Eccentricity error ( j ) = α sin ( {Φ}_{j} + β )\end{matrix} \qquad [ Equation 4 ]$$

Therefore, Δout (i, j) is expressed by the following equation (5).

$$Δ Out ( i , j ) = α sin ( {Φ}_{i} + β ) - α sin ( {Φ}_{j} + β ) \qquad [ Equation 5 ]$$

Then, when the equation (5) is modified, Δout (i, j) is expressed as the following equation (6).

$$Δ Out ( i , j ) = α \cdot Δ α ( i , j ) \cdot sin ( ΔΦ ( i , j ) + β ) \qquad [ Equation 6 ]$$

Here, Δα (i, j) and Δφ (i, j) are constants depending on the arrangement of the two detection heads. That is, Δout (i, j) becomes a sine wave whose amplitude is multiplied by Δα (i, j) and the phase is shifted by qi, j as compared with the eccentricity error when φ=0 is used as a reference. Therefore, when Out (i, j) divided by Δα (i, j) is plotted on the vertical axis and Δφ (i, j) is plotted on the horizontal axis, the plot is as illustrated in FIG. 8B. By fitting the plots to a sine wave, the amplitude and phase of the eccentricity error can be obtained.

Here, an example in which the coefficients a, b, and c are calculated by fitting to y=a+b·sin (θ)+c· cos (θ) showing the sine wave illustrated in FIG. 8B will be described. Here, in order to simplify the calculation, it is assumed that the first detection head 5-0 to the n-th detection heads 5-(n−1) are arranged at equal intervals.

The coefficients a, b, and c can be calculated by applying the least squares method using the following equation (7). In the equation (7), the A part and the B part are the parts determined by the arrangement of the detection heads. The C part is Δout (i, j)/Δα (i, j) obtained from the difference in the angular output of each detection head and the arrangement of the detection heads.

$$( \begin{matrix}\text{?} \\ \text{?} \\ \text{?}\end{matrix} ) = ( {\underbrace{\begin{matrix}\text{?} & \sum & \sum \\ \sum & \sum & \sum \\ \sum & \sum & \sum \end{matrix}}}_{A} ) \text{?} {\underbrace{( \begin{matrix}1 & 1 & … & 1 \\ \text{?} & \text{?} & … & \text{?} \\ \text{?} & \text{?} & … & \text{?}\end{matrix} )}}_{B} {\underbrace{( \begin{matrix}\text{?} \\ \text{?} \\ ⋮ \\ \text{?}\end{matrix} )}}_{C} \qquad [ Equation 7 ]$$

$$\text{?} \text{indicates text missing or illegible when filed}$$

Here, by arranging the detection heads at equal intervals, the A part becomes a diagonal matrix, so that the calculation becomes easy.

Equation (7) is a general equation when there are n number of detection heads. When there are four detection heads, the coefficients a, b, and c can be obtained by the following equation (8). Further, when the number of detection heads is eight, the coefficients a, b, and c can be obtained by the following equation (9).

$$( \begin{matrix}a \\ b \\ c\end{matrix} ) = {( \begin{matrix}4 & 0 & 0 \\ 0 & 2 & 0 \\ 0 & 0 & 2\end{matrix} )}^{- 1} ( \begin{matrix}1 & 1 & 1 & 1 \\ - 1 / \sqrt{2} & - 1 / \sqrt{2} & - 1 / \sqrt{2} & 1 / \sqrt{2} \\ - 1 / \sqrt{2} & 1 / \sqrt{2} & - 1 / \sqrt{2} & - 1 / \sqrt{2}\end{matrix} ) \cdot ( \begin{matrix}Δ out ( 1 , 0 ) / α ( 1 , 0 ) \\ Δ out ( 2 , 1 ) / α ( 2 , 1 ) \\ Δ out ( 3 , 2 ) / α ( 3 , 2 ) \\ Δ out ( 0 , 3 ) / α ( 0 , 3 )\end{matrix} ) \qquad [ Equation 8 ]$$

$$( \begin{matrix}a \\ b \\ c\end{matrix} ) = {( \begin{matrix}8 & 0 & 0 \\ 0 & 4 & 0 \\ 0 & 0 & 4\end{matrix} )}^{- 1} ( \begin{matrix}1 & 1 & 1 & 1 & 1 & 1 & 1 & 1 \\ - {t}_{1} & - {t}_{1} & - {t}_{2} & {t}_{2} & {t}_{1} & {t}_{1} & {t}_{2} & - {t}_{2} \\ - {t}_{2} & {t}_{2} & {t}_{1} & {t}_{1} & {t}_{2} & - {t}_{2} & - {t}_{1} & - {t}_{1}\end{matrix} ) \cdot ( \begin{matrix}Δ out ( 1 , 0 ) / α ( 1 , 0 ) \\ Δ out ( 2 , 1 ) / α ( 2 , 1 ) \\ ⋮ \\ Δ out ( 0 , 7 ) / α ( 0 , 7 )\end{matrix} ) {t}_{1} = cos ( 22.5 ° ) , {t}_{2} = sin ( 22.5 ° ) \qquad [ Equation 9 ]$$

By performing the above operations, the coefficients a, b, and c can be obtained, and y=a+b· sin (θ)+c· cos (θ), which is an equation indicating a sine wave, can be specified. Then, the relative movement amount X (eccentricity amount) along the X-axis direction can be obtained using the coefficient b in this equation. And the relative movement amount Y (eccentricity amount) along the Y-axis direction can be obtained using the coefficient c.

The relative movement amount X [mm] has a relationship as illustrated in FIG. 9A between the coefficients b [rad] and R [mm]. Here, R [mm] is the radius of the scale pattern 3.

Therefore, the relative movement amount X [mm] is calculated by the following equation 10.

$$\begin{matrix}X = R \times tan ( b ) \approx R \times b & ( R >> X )\end{matrix} \qquad [ Equation 10 ]$$

Similarly, the relative movement amount Y [mm] has a relationship as illustrated in FIG. 9B between the coefficients c [rad] and R [mm]. Here, R [mm] is the radius of the scale pattern 3.

Therefore, the relative movement amount Y [mm] is calculated by the following equation 11.

$$\begin{matrix}Y = R \times tan ( c ) \approx R \times c & ( R >> Y )\end{matrix} \qquad [ Equation 11 ]$$

In this way, the relative movement amount X [mm] and the relative movement amount Y [mm] can be calculated.

<When the rotary scale is rotating relatively> Next, a case where the rotary scale 2 is rotating relative to the detection head group will be described with reference to FIG. 8C. Specifically, a case where the rotary scale 2 rotates around the X-axis with respect to the detection head group and also rotates around the Y-axis with respect to the detection head group will be described. The relative rotation amount θx (tilt amount) around the X axis and the relative rotation amount θy (tilt amount) around the Y axis can be obtained from the amplitude and the phase of the gap fluctuation (distance between each detection head and the rotary scale 2).

When detecting the relative rotation amount θx and the relative rotation amount θy around the Y axis, the vertical axis is the gap in the sine wave illustrated in FIG. 8C. By plotting and fitting the gaps in each detection head from the first detection head 5-0 to the n-th detection head 5-(n−1) arranged in a circumferential shape, the coefficients a, b, and c of a sine wave (a+b· sin (θ)+c· cos (θ)) are obtained. The amplitude of this fitted sine wave becomes the amplitude of the gap fluctuation. That is, √(b2+c2) is the amplitude of the gap fluctuation.

The coefficients a, b, and c can be calculated by applying the least squares method using the following equation (12). In the equation (12), the A part and the B part are the parts determined by the arrangement of the detection heads. The C part is a matrix of the gap values in each detection head.

$$( \begin{matrix}a \\ b \\ c\end{matrix} ) = {\begin{matrix}( \begin{matrix}n & {\sum }_{k = 0}^{n - 1} sin {ϕ}_{k} & {\sum }_{k = 0}^{n - 1} cos {ϕ}_{k} \\ {\sum }_{k = 0}^{n - 1} sin {ϕ}_{k} & {\sum }_{k = 0}^{n - 1} {sin}^{2} {ϕ}_{k} & {\sum }_{k = 0}^{n - 1} sin {ϕ}_{k} cos {ϕ}_{k} \\ {\sum }_{k = 0}^{n - 1} cos {ϕ}_{k} & {\sum }_{k = 0}^{n - 1} sin {ϕ}_{k} cos {ϕ}_{k} & {\sum }_{k = 0}^{n - 1} {cos}^{2} {ϕ}_{k}\end{matrix} ) \\ A : 3 \times 3\end{matrix}}^{- 1} \cdot \begin{matrix}( \begin{matrix}1 & 1 & … & 1 \\ sin {ϕ}_{0} & sin {ϕ}_{1} & … & sin {ϕ}_{n - 1} \\ cos {ϕ}_{0} & cos {ϕ}_{2} & … & cos {ϕ}_{n - 1}\end{matrix} ) \\ B : 3 \times n\end{matrix} \cdot \begin{matrix}( \begin{matrix}{Z}_{0} \\ {Z}_{1} \\ ⋮ \\ {Z}_{n - 1}\end{matrix} ) \\ C : n \times 1\end{matrix} \qquad [ Equation 12 ]$$

Here, by arranging the detection heads at equal intervals, the A part becomes a diagonal matrix, so that the calculation becomes easy.

Equation (12) is a general equation when there are n number of detection heads. When there are four detection heads, the coefficients a, b, and c can be obtained by the following equation (13). Further, when the number of detection heads is eight, the coefficients a, b, and c can be obtained by the following equation (14).

$$( \begin{matrix}a \\ b \\ c\end{matrix} ) = {( \begin{matrix}4 & 0 & 0 \\ 0 & 2 & 0 \\ 0 & 0 & 2\end{matrix} )}^{- 1} \cdot ( \begin{matrix}1 & 1 & 1 & 1 \\ 0 & 1 & 0 & - 1 \\ 1 & 0 & - 1 & 1\end{matrix} ) \cdot ( \begin{matrix}{Z}_{0} \\ {Z}_{1} \\ {Z}_{2} \\ {Z}_{3}\end{matrix} ) \qquad [ Equation 13 ]$$

$$( \begin{matrix}a \\ b \\ c\end{matrix} ) = {( \begin{matrix}8 & 0 & 0 \\ 0 & 4 & 0 \\ 0 & 0 & 4\end{matrix} )}^{- 1} \cdot ( \begin{matrix}1 & 1 & 1 & 1 & 1 & 1 & 1 & 1 \\ 0 & 1 / \sqrt{2} & 1 & 1 / \sqrt{2} & 0 & - 1 / \sqrt{2} & - 1 & - 1 / \sqrt{2} \\ 1 & 1 / \sqrt{2} & 0 & - 1 / \sqrt{2} & - 1 & - 1 / \sqrt{2} & 0 & 1 / \sqrt{2}\end{matrix} ) \cdot ( \begin{matrix}{Z}_{0} \\ {Z}_{1} \\ {Z}_{2} \\ {Z}_{3} \\ {Z}_{4} \\ {Z}_{5} \\ {Z}_{6} \\ {Z}_{7}\end{matrix} ) \qquad [ Equation 14 ]$$

By performing the above operations, the coefficients a, b, and c can be obtained, and y=a+b· sin (θ)+c· cos (θ), which is an equation indicating a sine wave, can be specified. Then, the coefficient b in this equation can be used to obtain the relative rotation amount θx (inclination amount) around the X axis. And the coefficient c can be used to obtain the relative rotation amount θy (inclination amount) around the Y axis.

The relative rotation amount θx [rad] has a relationship as illustrated in FIG. 9C between the coefficients b [mm] and R [mm]. Here, R [mm] is the radius of the scale pattern 3.

Therefore, the relative rotation amount θx [rad] is calculated by the following equation 15.

$$\begin{matrix}θ x = tan - 1 ( b / R ) \approx b / R & ( R >> b )\end{matrix} \qquad [ Equation 15 ]$$

Similarly, the relative rotation amount θy [rad] has a relationship as illustrated in FIG. 9D between the coefficients c [mm] and R [mm]. Here, R [mm] is the radius of the scale pattern 3.

Therefore, the relative rotation amount θy [rad] is calculated by the following equation 16.

$$\begin{matrix}θ y = tan - 1 ( c / R ) \approx c / R & ( R >> c )\end{matrix} \qquad [ Equation 16 ]$$

In this way, the relative rotation amount θx [rad] and the relative rotation amount θy [rad] can be calculated.

The rotary encoder 1 can detect the amount of eccentricity when the rotary scale 2 is eccentric, and the amount of inclination when the rotary scale 2 is tilted. In the above description, these are explained separately. In other words, with reference to FIG. 4, FIG. 4B, and FIG. 6, the detection of the amount of eccentricity in a posture situation in which the rotary scale 2 is eccentric will be explained. And, with reference to FIG. 5A, FIG. 5B and FIG. 7, detection of the amount of inclination in a situation where the rotary scale 2 is in an inclined position will be described. However, the rotary encoder 1 can simultaneously detect the amount of eccentricity and the amount of inclination even if the rotary scale 2 is eccentric and tilted.

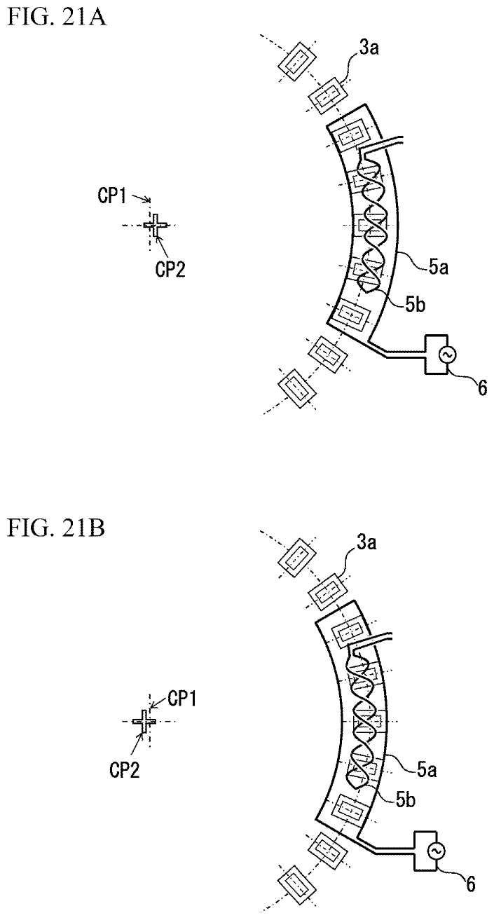

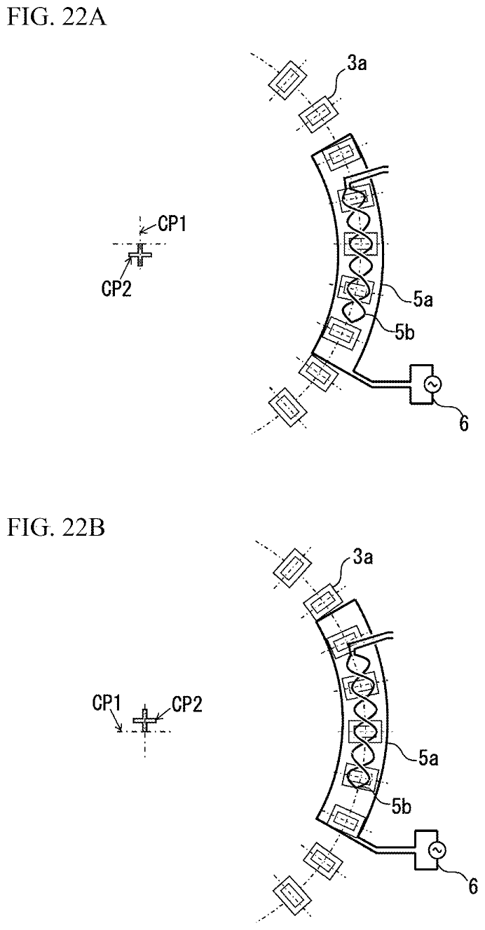

Here, a movable area of the pattern 3a provided in the scale pattern 3 with respect to the rotary scale 2 will be described with reference to FIG. 21A to FIG. 22B. FIG. 21A to FIG. 22B all illustrate a part of the rotary encoder 1 viewed from the Z-axis direction. In FIG. 21A to FIG. 22B, the reference numeral CP1 is the center of the scale pattern 3, and is indicated by a cross shape drawn by a dashed line. Further, reference numeral CP2 is the rotation center of the rotary scale 2, and is indicated by a solid cross-shaped figure. The transmitting coil 5a and the receiving coil 5b are arranged circumferentially around the rotation center CP2. FIG. 21A to FIG. 22B illustrate how the center CP1 of the scale pattern 3 and the rotation center CP2 of the rotary scale 2 are slightly shifted relative to each other. The scale pattern 3 and the rotary scale 2 are provided so that when the eccentricity and inclination of the rotary scale 2 are detected simultaneously, the pattern 3a can maintain the state described below. In other words, the scale pattern 3 and the rotary scale 2 are designed so that the pattern 3a does not protrude from the magnetic flux generation area generated by the transmitting coil 5a of each detection head, as illustrated in FIG. 21A to FIG. 22B.

The measuring device 50 of the present embodiment includes n number of detection heads 5-0 to 5-(n−1), so that the position coordinates of the detection heads included in the detection heads 5-0 to 5-(n−1) can be output in the P (r, θ, Z) cylindrical coordinate system. That is, by using the detection value of the detection head other than the detection head that is the output target of the position coordinates, the position coordinates of the target detection head can be known. By outputting the position coordinates of the detection heads included in the detection heads 5-0 to 5-(n−1) to each other, it becomes possible to measure the multi-degree-of-freedom displacement.

As described above, the rotation center of the rotary scale 2 in the rotary encoder 1 and the central axis of the detection heads 5-0 to 5-(n−1) arranged in a circumferential shape are both the Z axis. When the rotary encoder 1 is installed on the measurement target, such a positional relationship between the rotary encoder 1 and the detection heads 5-0 to 5-(n−1) is guaranteed. Here, the measurement target of the rotary encoder 1 is assumed to be, for example, a joint portion in a robot, a rotating member on which a tool is mounted in a machine tool, or the like. Robots and machine tools may be displaced due to aging and the load applied to each part due to use. With the measuring device 50 of the present embodiment, it is possible to measure this displacement. That is, the state of the measurement target can be grasped by measuring the multi-degree-of-freedom displacement with the state when the rotary encoder 1 is installed as the initial state and the state as a reference.

It should be noted that the distance between the detection heads in each figure, the dimensions of each detection head, and the dimensions of the rotary scale 2 may not be necessarily accurately illustrated. Further, the dimensions of the pattern 3a and the distance between the patterns 3a in each figure may not be necessarily accurately illustrated.

Next, with reference to FIG. 3A and FIG. 3B, the displacement with multiple degrees of freedom that can be measured by the measuring device 50 of the embodiment will be described. As illustrated in FIG. 3A and FIG. 3B, the rotary encoder 1 is installed so that its rotation center coincides with the Z axis. At this time, the rotary scale 2 is installed so that the X-axis orthogonal to the Z-axis and the Y-axis orthogonal to the Z-axis and the X-axis each penetrate in the radial direction. Here, the Z axis corresponds to the first rotation axis, the X axis corresponds to the second rotation axis, and the Y axis corresponds to the third rotation axis.

As illustrated by +X and −X in FIG. 3A, the measuring device 50 can detect a relative movement amount between a detection head group including the detection heads 5-0 to 5-(n−1) and the rotary scale 2 in the X-axis direction. Further, as illustrated by +Y and −Y in FIG. 3A, the measuring device 50 can detect a relative movement along the Y-axis between the detection head group including the detection heads 5-0 to 5-(n−1) and the rotary scale 2. Further, as illustrated by +Z and −Z in FIG. 3A, the measuring device 50 can detect a relative movement amount along the Z-axis direction between the detection head group including the detection heads 5-0 to 5-(n−1) and the rotary scale 2.

As illustrated by +θx and −θx in FIG. 3B, the measuring device can detect a relative rotation angle around the X-axis between the detection head group including the detection heads 5-0 to 5-(n−1) and the rotary scale 2 around the X axis. Further, as illustrated by +θy and −θy in FIG. 3B, the measuring device 50 can detect a relative rotation angle around the Y-axis between detection head group including the detection heads 5-0 to 5-(n−1) and the rotary scale 2. Further, as illustrated by +θz and −θz in FIG. 3B, the measuring device 50 has can detect a relative rotation angle around the Z-axis between the detection head group including the detection heads 5-0 to 5-(n−1) and the rotary scale 2.

Of the above six degrees of freedom, the relative rotation angle around the Z axis between the detection head group including the detection heads 5-0 to 5-(n−1) and the rotary scale 2 is one of the displacements of the degree of freedom measured by a normal rotary encoder. In the measuring device 50 of the present embodiment, the relative rotation angle around the Z axis can be measured in the same manner as the conventional rotary encoder. The measuring device 50 of the embodiment can measure the displacement of other degrees of freedom in addition to the relative rotation angle around the Z axis.

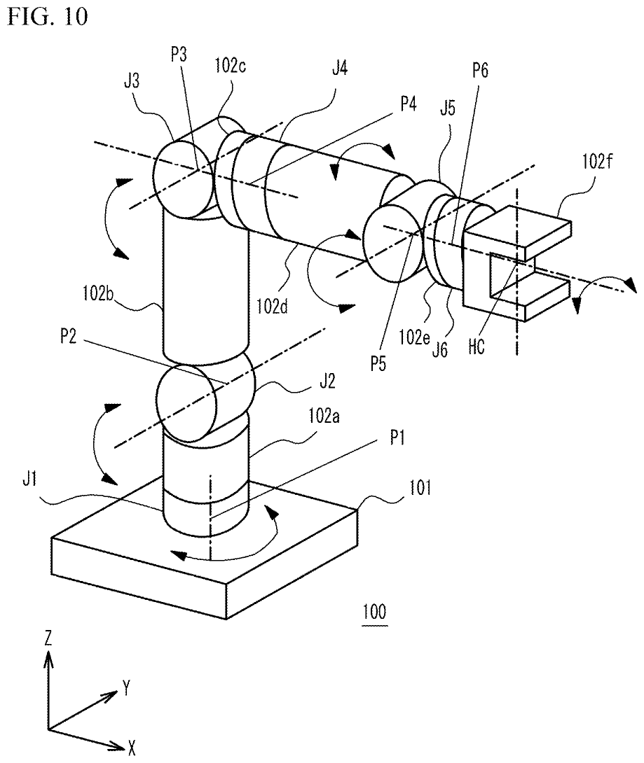

(First Example) Next, with reference to FIG. 10 to FIG. 12, a robot 100 as a first embodiment to which the measuring device 50 of the embodiment can be applied will be described. The robot 100 is a so-called industrial robot used for assembly work in factories and the like.

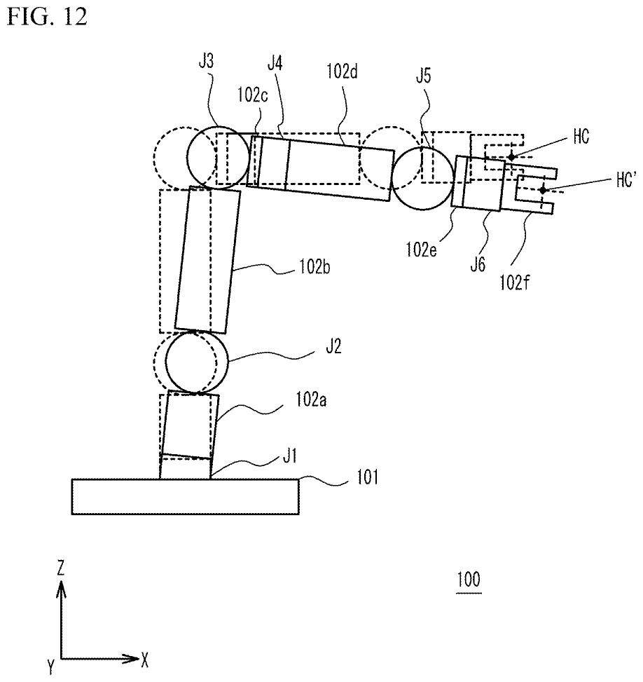

The robot 100 includes a base portion 101 and a first link member 102a to a sixth link member 102f. The base portion 101 serves as a base. In the base portion 101, a reference point P1 for the coordinates of each portion of the robot 100 is set. The sixth link member 102f is an end effector which is a hand portion for holding a work object. Joint portions J1 to J6 are provided at the connecting portions of the link members. A motor (not illustrated) and the rotary encoder 1 as illustrated in FIG. 1 are incorporated in each of the joint portions J1 to J6. The configuration in which the motor and the rotary encoder are incorporated in the joint portions J1 to J6 is a conventionally known configuration, and in FIG. 10 and FIG. 12, the motor and the rotary encoder incorporated in the joint portions J1 to J6 are omitted.

The first joint portion J1 is provided between the base portion 101 and the first link member 102a. The second joint portion J2 is provided between the first link member 102a and a second link member 102b. The third joint portion J3 is provided between the second link member 102b and a third link member 102c. The fourth joint portion J4 is provided between the third link member 102c and a fourth link member 102d. The fifth joint portion J5 is provided between the fourth link member 102d and a fifth link member 102e. The sixth joint portion J6 is provided between the fifth link member 102e and the sixth link member (end effector) 102f. The center points of the rotary encoder 1 provided in each joint are P1, P2, P3, P4, P5 and P6, respectively. The position of the sixth link member 102f is represented by the gripping point HC. In the control of the robot 100, the coordinates of the gripping point HC with respect to the coordinates (0,0,0) of the reference point P1 are instructed. Specifically, the motors provided in the joint portions J1 to J6 are operated so that the coordinate of the gripping point HC becomes the target coordinates. The center points P1 to P6 and the gripping point HC are calculated sequentially from the reference point P1 in consideration of the rotation angle (rotation amount) of the motor at each joint portion J1 to J6 and the dimensions of each link member.

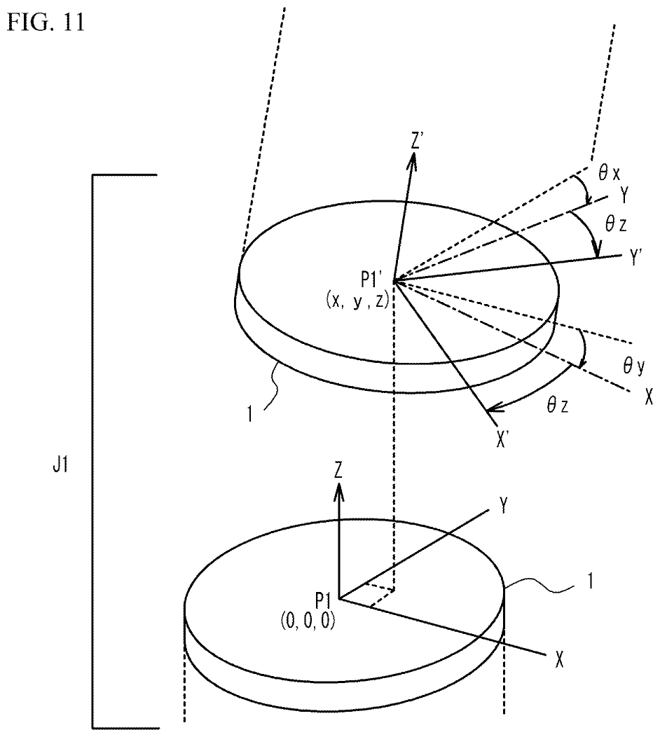

Here, with reference to FIG. 11 and FIG. 12, changes in 6 degrees of freedom (X, Y, Z, θx, θy, θz) in the first joint portion J1 will be described. The rotary encoder 1 provided in the first joint portion J1 is installed in a state where the Z axis is passed through the reference point P1 whose coordinates are (0,0,0). Since the motor incorporated in the first joint portion J1 rotates the first link member 102a around the Z axis, it is θz that is actively changed by operating the motor. However, for various causes, for example, when the sixth link member 102f grips the gripping object, the weight of the gripping object causes tilting of the first link member 102a or later with respect to the base portion 101 as illustrated in FIG. Further, the first link member 102a or later may be eccentric in the X-axis direction or the Y-axis direction due to wear of the member forming the shaft portion or the like.

When such a phenomenon occurs, among the 6 degrees of freedom (X, Y, Z, θx, θy, θz), in addition to the rotation angle θz around the Z axis, any of the remaining 5 degrees of freedom also changes. If the remaining 5 degrees of freedom has moved in the X-axis direction, the Y-axis direction, and the Z direction, the reference point P1 becomes the reference point P1′, and its coordinates (0,0,0) are updated to (x, y, z). When the rotation ex around the X axis and the rotation θy around the Y axis are measured, the Z′-axis tilted in consideration of these rotations is set. The Z′-axis passes through the new reference point P1′. Further, new X′-axis and Y′-axis are set in consideration of the original rotation θz around the Z-axis. In this way, the X-axis, Y-axis, and Z-axis are updated to the X′-axis, Y′-axis, and Z′-axis. When such a displacement with multiple degrees of freedom occurs, the X-axis, Y-axis, and Z-axis are updated.

Such updating of the X-axis, Y-axis and Z-axis is also performed in each joint portion J2 to J6. As a result, the position of the gripping point HC in which the target coordinates are set is actually the gripping point HC′, and the coordinates are deviated from the target coordinates.

The coordinates of the actual gripping point HC′ are calculated sequentially by considering the displacement of multiple degrees of freedom detected by the rotary encoder 1 in each joint portion J1 to J6 and the dimensions of each link member.

When the coordinates of the actual gripping point HC′ calculated in this way and the coordinates of the gripping point HC of the target value deviate as illustrated in FIG. 12, the robot 100 performs position correction control so that deviation of the coordinating portion is canceled. Since a conventionally known method can be adopted for the position correction control itself, a detailed description thereof will be omitted here.

As a result, the robot 100 can grasp the posture of the robot 100 and the deviation of the gripping point HC without preparing a separate measuring device other than the rotary encoder 1. Then, the deviation can be corrected.

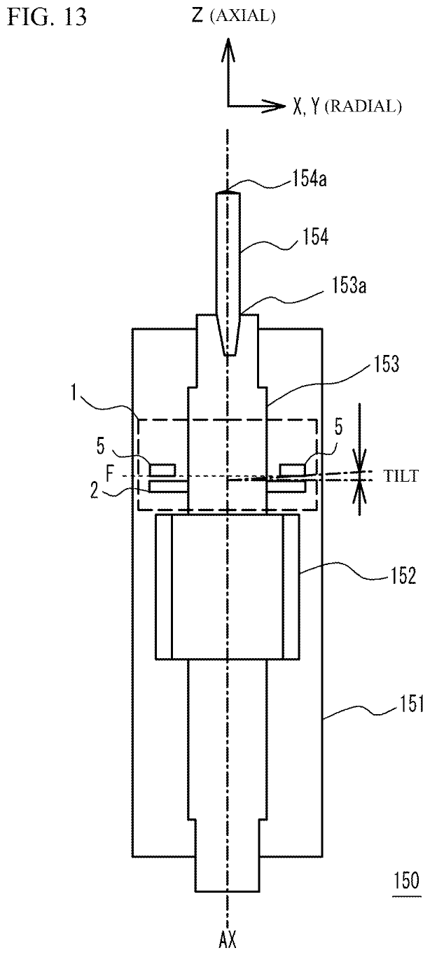

(Second Example) Next, with reference to FIG. 13, a machine tool 150 as a second example to which the measuring device 50 of the embodiment can be applied will be described. The machine tool 150 performs cutting, polishing, and the like on a work (not illustrated).

The machine tool 150 includes a cylindrical main body portion 151, a drive motor 152 housed in the main body portion 151, and a rotating member 153 rotatably provided by the drive motor 152. The drive motor 152 rotates the rotating member 153 around the rotating spindle AX. A chuck portion 153a is provided at the tip portion of the rotating member 153. Various tools can be attached to the chuck portion 153a, but in the present embodiment, a cutting tool 154 is attached to the chuck portion 153a. The rotary encoder 1 is provided in the main body portion 151. The rotary scale 2 included in the rotary encoder 1 is fixed to the rotating member 153 and rotates together with the rotating member 153. The detection head 5 included in the rotary encoder 1 is fixed to the inner peripheral wall surface of the main body portion 151. A plurality of detection heads 5 are provided, and these detection heads 5 are arranged in a circumferential shape on a virtual installation surface F facing the rotary scale 2. The rotary encoder 1 is provided so that the rotation axis AX and the axial (Z-axis) direction coincide with each other.

In the machine tool 150, the rotation angle θz around the Z axis is measured by the rotary encoder 1, and the remaining 5 degrees of freedom other than this are appropriately measured.

The machine tool 150 can calculate the accurate coordinates of a tip portion 154a of the cutting tool 154 by measuring the displacement with multiple degrees of freedom. When the displacement with multiple degrees of freedom is measured by the rotary encoder 1, the coordinates of the tip portion 154a deviate from the target coordinates. Therefore, the machine tool 150 performs a correction operation so as to correct the deviation of the coordinates of the tip portion 154a. As a result, the machine tool 150 can perform machining with higher accuracy.

Further, the machine tool 150 of the second example can monitor the operating state of the rotating member 153. Specifically, by measuring the displacement with multiple degrees of freedom, it is possible to detect the modulation of the drive motor 152 and the rotating member 153 and predict these failures. That is, the rotary encoder 1 makes it possible to monitor the state of the rotating shaft (eccentricity, tilt, vibration thereof) with a simple configuration without adding another sensor, which can be useful for machine failure prediction.

According to the measuring device 50 of the present embodiment, it is possible to measure the movement of the object to be measured rotating around a plurality of axes and the movement along a plurality of axial directions. That is, the rotation angle θz around the Z axis can be measured, and the remaining 5 degrees of freedom other than this can be appropriately measured.

The present invention is not limited to the specifically disclosed embodiments and variations but may include other embodiments and variations without departing from the scope of the present invention.

What is claimed is:

1. A multi-degree-of-freedom displacement measuring device comprising:
a rotary scale that has a scale pattern including a plurality of patterns that are arranged around a first rotation axis and arrayed along a circumference direction of the rotary scale;
a detection head group including a plurality of detection heads, each of which is provided around the first rotation axis, is arranged on an installation face facing the rotary scale, and is configured to detect each of the plurality of patterns from the scale pattern; and
a calculator configured to, based on detection values acquired by the plurality of detection heads, calculate a relative rotation angle around the first rotation axis, and calculate at least one of a relative movement amount in a direction along the first rotation axis and a relative movement amount in a direction along a second rotation axis orthogonal to the first rotation axis.

2. A multi-degree-of-freedom displacement measuring device comprising:
a rotary scale that has a scale pattern including a plurality of patterns that are arranged around a first rotation axis and arrayed along a circumference direction of the rotary scale;
a detection head group including a plurality of detection heads, each of which is provided around the first rotation axis, is arranged on an installation face facing the rotary scale, and is configured to detect each of the plurality of patterns from the scale pattern; and
a calculator configured to, based on detection values acquired by the plurality of detection heads, calculate a relative rotation angle around the first rotation axis, and calculate at least one of a relative movement amount in a direction along the first rotation axis and a relative rotation angle in a direction along a second rotation axis orthogonal to the first rotation axis.

3. A multi-degree-of-freedom displacement measuring device comprising:
a rotary scale that has a scale pattern including a plurality of patterns that are arranged around a first rotation axis and arrayed along a circumference direction of the rotary scale;
a detection head group including a plurality of detection heads, each of which is provided around the first rotation axis, is arranged on an installation face facing the rotary scale, and is configured to detect each of the plurality of patterns from the scale pattern; and
a calculator configured to, based on detection values acquired by the plurality of detection heads, calculate a relative rotation angle around the first rotation axis, and calculate at least one of a relative movement amount in a direction along the second rotation axis orthogonal to the first rotation axis and a relative rotation angle around the second rotation axis.

4. The multi-degree-of-freedom displacement measuring device as claimed in claim 1,
wherein a number of the plurality of detection heads is three or more, and
wherein the calculator is configured to, based on the detection values acquired by the plurality of detection heads, calculate the relative rotation angle around the first rotation axis, and calculate at least one of a relative movement amount in a direction along the first rotation axis, a relative movement amount in a direction along the second rotation axis, and a relative movement amount in a direction along a third rotation axis orthogonal to the first rotation axis and the second rotation axis.

5. The multi-degree-of-freedom displacement measuring device as claimed in claim 2,
wherein a number of the plurality of detection heads is three or more, and
wherein the calculator is configured to, based on the detection values acquired by the plurality of detection heads, calculate the relative rotation angle around the first rotation axis, and calculate at least one of a relative movement amount in a direction along the first rotation axis, a relative rotation angle around a second rotation axis orthogonal to the first rotation angle, and a relative rotation angle around a third rotation axis orthogonal to the first rotation axis and the second rotation axis.

6. The multi-degree-of-freedom displacement measuring device as claimed in claim 3,
wherein a number of the plurality of detection heads is three or more, and
wherein the calculator is configured to, based on the detection values acquired by the plurality of detection heads, calculate the relative rotation angle around the first rotation axis, and simultaneously calculate at least two of a relative movement amount in a direction along the first rotation axis, a relative movement amount in a direction along the second rotation axis, a relative movement amount in a direction along a third rotation axis orthogonal to the first rotation axis and the second rotation axis, a relative rotation angle around the second rotation axis and a relative rotation angle around the third rotation axis.

7. The multi-degree-of-freedom displacement measuring device as claimed in claim 1,
wherein the installation face is in parallel with the rotary scale, and
wherein the calculator calculates a distance between the rotary scale and each of the plurality of detection heads on a basis of each strength of each detection signal detected by each of the plurality of detection heads, and determines that the rotary scale and the detection head group are in a state that the rotary scale and the detection head group relatively move along the first rotation axis when each of the distance is equal to each other, and determines that the distance is a distance in which the rotary scale and the detection head group relatively move.

8. The multi-degree-of-freedom displacement measuring device as claimed in claim 1,
wherein the plurality of detection heads are arranged at an equal interval along a circumference direction of the scale pattern.

9. The multi-degree-of-freedom displacement measuring device as claimed in claim 1,
wherein each of the plurality of detection heads has a receiving coil, and
wherein the receiving coil includes the installation face and is formed in a predetermined range in a direction orthogonal to the installation face.

10. The multi-degree-of-freedom displacement measuring device as claimed in claim 9,
wherein the receiving coil has a predetermined thickness, is installed in an installation area that is centered on the installation face and extends in both directions perpendicular to the installation face, and
wherein the installation area is an area where a vertical distance from the installation face corresponds to the predetermined thicknesses of the receiving coil in both directions of the installation face.

11. The multi-degree-of-freedom displacement measuring device as claimed in claim 10,
wherein a midline in a thickness direction of the receiving coil coincides with the installation face.

12. The multi-degree-of-freedom displacement measuring device as claimed in claim 3,
wherein the installation face is in parallel with the rotary scale, and
wherein the calculator calculates a distance between the rotary scale and each of the plurality of detection heads on a basis of each strength of each detection signal detected by each of the plurality of detection heads, and determines that the rotary scale and the detection head group are in a state that the rotary scale and the detection head group relatively move along the first rotation axis when each of the distance is equal to each other, and determines that the distance is a distance in which the rotary scale and the detection head group relatively move.

13. The multi-degree-of-freedom displacement measuring device as claimed in claim 3,
wherein the plurality of detection heads are arranged at an equal interval along a circumference direction of the scale pattern.

14. The multi-degree-of-freedom displacement measuring device as claimed in claim 3,
wherein each of the plurality of detection heads has a receiving coil, and
wherein the receiving coil includes the installation face and is formed in a predetermined range in a direction orthogonal to the installation face.

15. The multi-degree-of-freedom displacement measuring device as claimed in claim 14,
wherein the receiving coil has a predetermined thickness, is installed in an installation area that is centered on the installation face and extends in both directions perpendicular to the installation face, and
wherein the installation area is an area where a vertical distance from the installation face corresponds to the predetermined thicknesses of the receiving coil in both directions of the installation face.

16. The multi-degree-of-freedom displacement measuring device as claimed in claim 15,
wherein a midline in a thickness direction of the receiving coil coincides with the installation face.

17. The multi-degree-of-freedom displacement measuring device as claimed in claim 5,
wherein the installation face is in parallel with the rotary scale, and
wherein the calculator calculates a distance between the rotary scale and each of the plurality of detection heads on a basis of each strength of each detection signal detected by each of the plurality of detection heads, and determines that the rotary scale and the detection head group are in a state that the rotary scale and the detection head group relatively move along the first rotation axis when each of the distance is equal to each other, and determines that the distance is a distance in which the rotary scale and the detection head group relatively move.

18. The multi-degree-of-freedom displacement measuring device as claimed in claim 5,
wherein the plurality of detection heads are arranged at an equal interval along a circumference direction of the scale pattern.

19. The multi-degree-of-freedom displacement measuring device as claimed in claim 5,
wherein each of the plurality of detection heads has a receiving coil, and
wherein the receiving coil includes the installation face and is formed in a predetermined range in a direction orthogonal to the installation face.

20. The multi-degree-of-freedom displacement measuring device as claimed in claim 19,
wherein the receiving coil has a predetermined thickness, is installed in an installation area that is centered on the installation face and extends in both directions perpendicular to the installation face, and
wherein the installation area is an area where a vertical distance from the installation face corresponds to the predetermined thicknesses of the receiving coil in both directions of the installation face.

21. The multi-degree-of-freedom displacement measuring device as claimed in claim 20,
wherein a midline in a thickness direction of the receiving coil coincides with the installation face.

22. A measuring method of multi-degree-of-freedom displacement for measuring a multi-degree-of-freedom displacement by using a detection device including a rotary scale that has a scale pattern including a plurality of patterns that are arranged around a first rotation axis and arrayed along a circumference direction of the rotary scale, and a detection head group including a plurality of detection heads, each of which extends around the first rotation axis, is arranged on an installation face facing the rotary scale, and is configured to detect each of the plurality of patterns from the scale pattern, the method comprising:
based on detection values acquired by the plurality of detection heads, calculating a relative rotation angle around the first rotation axis; and
calculating at least one of a relative movement amount in a direction along the first rotation axis and a relative movement amount in a direction along a second rotation axis orthogonal to the first rotation axis.

23. A measuring method of multi-degree-of-freedom displacement for measuring a multi-degree-of-freedom displacement by using a detection device including a rotary scale that has a scale pattern including a plurality of patterns that are arranged around a first rotation axis and arrayed along a circumference direction of the rotary scale, and a detection head group including a plurality of detection heads, each of which extends around the first rotation axis, is arranged on an installation face facing the rotary scale, and is configured to detect each of the plurality of patterns from the scale pattern, the method comprising:
based on detection values acquired by the plurality of detection heads, calculating a relative rotation angle around the first rotation axis; and
calculating at least one of a relative movement amount in a direction along the first rotation axis and a relative rotation angle around a second rotation axis orthogonal to the first rotation axis.

24. A measuring method of multi-degree-of-freedom displacement for measuring a multi-degree-of-freedom displacement by using a detection device including a rotary scale that has a scale pattern including a plurality of patterns that are arranged around a first rotation axis and arrayed along a circumference direction of the rotary scale, and a detection head group including a plurality of detection heads, each of which extends around the first rotation axis, is arranged on an installation face facing the rotary scale, and is configured to detect each of the plurality of patterns from the scale pattern, the method comprising:
based on detection values acquired by the plurality of detection heads, calculating a relative rotation angle around the first rotation axis; and
simultaneously calculating a relative movement amount in a direction along a second rotation axis orthogonal to the first rotation axis and a relative rotation angle around the second rotation axis.
